(19) United States
(12) Patent Application Publication
(10) Pub. No.: US 2005/0010585 A1
(43) Pub. Date: Jan. 13, 2005

(54) Specifying management nodes in a device management system

(75) Inventors: Mikko Sahinoja, Tampere (FI); Eero Kaappa, Tampere (FI); Mika Hallamaa, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/878,107

(22) Filed: Jun. 28, 2004

(30) Foreign Application Priority Data
Jul. 1, 2003 (FI) 20030993

(51) Int. Cl. G06F 17/00

(52) U.S. Cl. 707/100

(57) ABSTRACT

The invention relates to a method for specifying information on a management node used for device management in a system comprising a first device and a second device managing the first device. In accordance with the method, at least one piece of management node information specified by a first device is transmitted from the first device to a second device as a response to at least one piece of information on a management node used for device management being specified in the first device.

### FIELD OF THE INVENTION

The invention relates to specifying management nodes, which are used in device management, in a device management system.

### BACKGROUND OF THE INVENTION

As data processing devices, such as mobile stations, are getting more and more complex, device management increases in importance. Devices require a variety of different settings, such as those related to Internet access points, the setting of which manually by the user is difficult. To solve this and other problems, device management solutions have been provided with which the administrator of a company data system or a teleoperator, for example, can set an appropriate configuration in a device. Generally, device management refers to measures with which the configuration of a device can be changed from outside the device, for instance by changing settings or even a protocol used by the device. In addition to settings related to the device only, also user-specific data can be sent, for instance user profiles, logos, ringing tones and menus with which the user can modify device settings to be personal. Alternatively, such modification can take place automatically in connection with device management.

One device management standard is OMA (Open Mobile Alliance) device management, which is partly based on the SyncML protocol. OMA device management also comprises client-provisioning technology OMA CP, in which the configuration is transmitted to a client device by using provisioning technology. Device management (OMA DM) based on SyncML technology, in turn, is bidirectional technology. A PC (personal computer), for instance, can serve as the device management server, and a mobile station can serve as the device management client. The client device that functions, from the device management viewpoint, as the client in the session sends information on itself to the management server performing device management in the session initialization message, and the management server replies to this by sending its own information as well as server management commands. The client device replies to these with status information, after which the server can end the session or send more device management commands. If the server sends more management commands, the client device must reply to these with status information. After receiving the status information, the server can always end the session, or it can continue the session by transmitting more device management commands. Device management may also be implemented in such a way that first the user is sent questions about what he wishes to update, and then information on the user's choices is sent to the server. After this the server can, in the next packet, transmit the updates/operations that the user wishes to have.

In a client device, the matters to be managed are arranged as management objects. Management objects are entities in the client device that can be managed by management commands of the management server. A management object may be, for instance, a figure or a large entity, such as a background image or a screen saver. Possibly, at least part of the management objects are standardized; the OMA device management standards presently contain three standardized management objects.

In OMA device management, the management objects are arranged in the form of a tree, i.e. as a management tree illustrated in FIG. 1. The management tree is formed of nodes, and the management object is a subtree to the management tree and can be formed of one or more nodes. After this, it is the nodes forming management objects that are dealt with. A node can be a single parameter, a subtree or a collection of data. For instance, node “Vendor” is an interior node, because it has child nodes “Screen Saver” and “Ringing Tones”. Node “Screen Saver” is a leaf node, because it has no child nodes. Also node “Ringing Tones” is an interior node, because it has child nodes. The contents of a node may also be a link addressing another node. Each node can be addressed with a URI (Uniform. Resource Identifier). The URI of a node is formed beginning from root “/”, and when proceeding onwards in the tree, each node has a name that is added to the previous nodes by using “/” as a separating sign. For instance, node “Ringing Tones” may be addressed with URI identifier “Vendor/Ringing Tones/”. The nodes can be permanent or dynamic. Dynamic nodes can be added from a client device or management server.

A name (which functions as the address) must be allocated in the management tree to a new dynamic node in order for the information contained in the management tree to be available in both the management server and the client device. If the name of the node to be added to the management tree is selected in the client device, the same name has not been set for the node in the management server, whereby the management commands given by the management server cannot be implemented. Particularly in devices utilizing client provisioning technology, nodes contained in bootstrap messages must, in some way, be arranged in the management tree, or the nodes cannot necessarily be stored as such, but at least the name of the node must typically be specified in the client device. Thus, in some cases the client device must modify the management tree. As the OMA specification “SyncML Device Management Tree and Description”, version 1.1.1; 2 Oct. 2002; 48 pages, Chapter 7 presents, the management server may request a part of the management tree from the client device, in which case the client device replies by transmitting the management tree part requested by the management server. However, the management server is not necessarily capable of requesting for the management tree even if it has been modified in the client device. It may also be the case that the client device has modified the management tree in such a way that the request of the management server cannot be replied to, because the requested part does not exist or it has another name.

### BRIEF DESCRIPTION OF THE INVENTION

An object of the invention is to improve specification of management nodes in such a way that the above-mentioned problem could be avoided or alleviated. The objects of the invention are achieved with a method, device management system, data processing devices and computer program product characterized in what is presented in the independent claims. Preferred embodiments of the invention are described in the dependent claims.

In accordance with the invention, at least one piece of management node information specified by a first device is transmitted from the first device to a second device as a response to at least one piece of information on a management node to be used for device management being specified in the first device. A management node refers generally to an entity relating to device management and being configurable by a third party, for example to settings of an Internet access point, without being restricted to nodes of the OMA device management. Management nodes can be organized as management structures. A management structure can be a structure of any form that contains management nodes, without being restricted to the tree-form OMA device management trees. Specifying a management node in the first device means that at least part of the node information, for instance the location or name of the management node, has been determined in the first device. It is to be noted that part of the management node information specified by the first device may be based on a management command received from the second device, for instance a message containing Bootstrap information.

An advantage of the solution according to the invention is that information on at least the modified management nodes can be automatically transmitted from the first device, for instance a device functioning as the client device of the OMA device management. Thus, the second device, for instance the management server of the OMA device management, does not have to request for the management structure of the first device and properties of its nodes separately; so request-related problems can be avoided. By means of the invention, the first device can also independently modify nodes, yet allowing the second device to manage the modified nodes, because information on the modifications can be transmitted to the second device.

In accordance with an embodiment of the invention, specifying and transmitting information on management nodes are performed as a response to the management message received from the second device. Hereby, the second device receives quickly the information on the modifications made in the first device and has thus the correct management information on the management nodes of the first device.

In accordance with a second embodiment of the invention, the management node information transmitted from the first device to the second device comprises at least the name of the management node in the management structure. In the OMA device management node, for example, the name or other identification information is used to address the node in question, so that by means of this embodiment the first device can name the nodes in a desired way or give them other identification information, and the second device can still address the nodes in the right manner.

### BRIEF DESCRIPTION OF THE FIGURES

The invention will now be described in greater detail in connection with some embodiments, with reference to the attached drawings, of which:

FIG. 1 illustrates a management tree;

FIG. 2 illustrates a management system;

FIG. 3 illustrates a server and a client device;

FIGS. 4a and 4b illustrate a method according to an embodiment of the invention; and

FIGS. 5a and 5b are signalling diagrams illustrating data transmission between a client device and a management server in accordance with some embodiments of the invention.

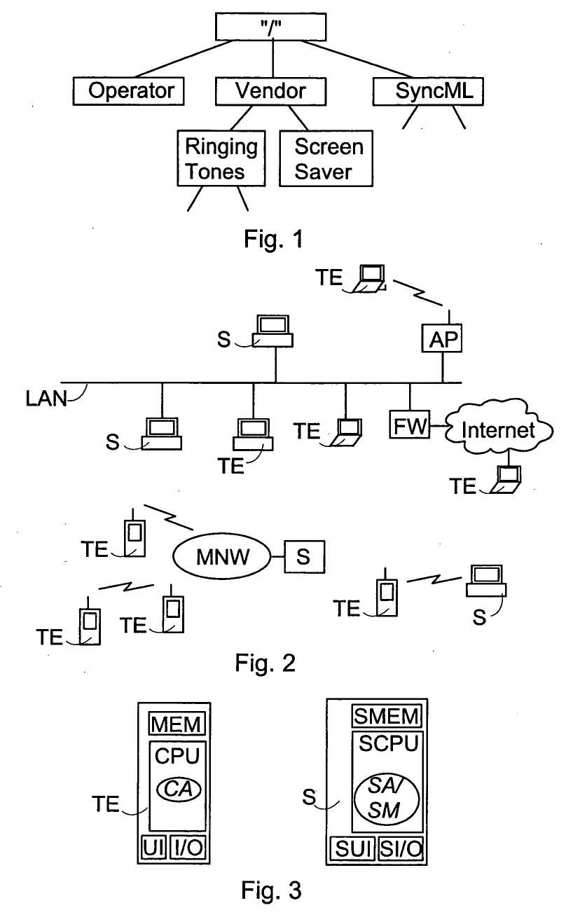

### DETAILED DESCRIPTION OF THE INVENTION

The following describes an embodiment of the invention in a system supporting OMA device management. It is to be noted, however, that the invention can be applied to any device management system in which information on device management nodes can be specified in a client device.

FIG. 2 illustrates a networked system. A network server or a PC typically functions as the server S. TE is typically a mobile station, a PC, a laptop computer or a PDA device (Personal Digital Assistant). In the following embodiments, it is assumed that from the device management point of view, the terminal TE functions as the client device and the server S functions as the management server. The server S may manage several client devices TE.

FIG. 2 illustrates two examples, in the first of which client devices TE and management servers S are connected to a local area network LAN. The client device TE connected to the network LAN comprises functionality, for instance a network interface card and software that controls data transmission, to communicate with devices in the network LAN. The local area network LAN can be a local area network of any type, and the TE may also communicate with the server S via the Internet, typically by using a firewall FW. The terminal TE may also be connected to the local area network LAN wirelessly via an access point AP.

In the second example, the terminal TE communicates with the server S via a mobile network MNW. The terminal TE connected to the network MNW comprises mobile station functionality to communicate with the network MNW wirelessly. There may additionally be other networks, such as a local area network LAN, between the mobile network MNW and the server S. The mobile network MNW can be any known wireless network, for instance a network supporting the GSM service, a network supporting the GPRS service (General Packet Radio Service), a third-generation mobile network, e.g. a network conforming to the network specifications of the 3GPP (3^{rd} Generation Partnership Project), a wireless local area network WLAN, a private network or a combination of networks. In many mobile networks, an important service of the transport layer is WAP, which contains a WSP (Wireless Session Protocol) layer, by means of which the device management application layer can be provided with a transport service in the client device TE and server S. In such a case, the system comprises at least one WAP gateway and possibly one or more WAP proxies. The WAP supports several lower-layer transmission techniques, such as the HTTP or OBEX standards. Lower-layer transmission techniques can be used in the way similar to circuit-switched or packet-switched data transmission or SMS-based transmission in accordance with the properties of the underlying mobile network MNW. In addition to those in the above examples, also other device management configurations are feasible, such as a management connection between the TE and the server S by using a wired or wireless connection directly without other network elements.

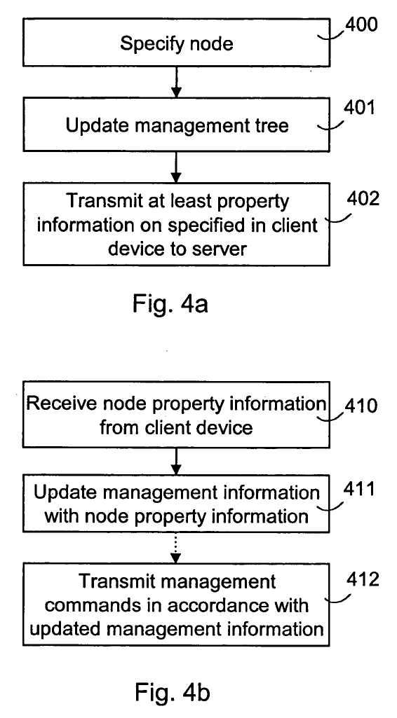

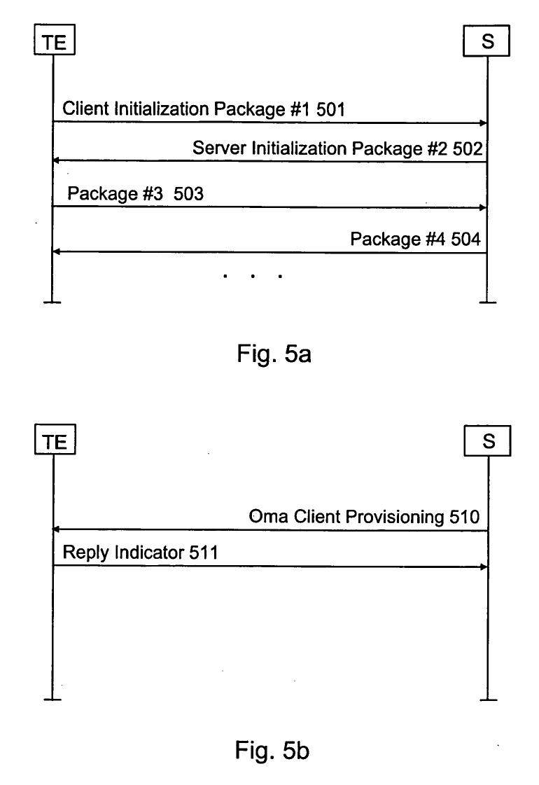

As shown in FIG. 3, the terminal TE and the server S comprise memory MEM, SMEM; a user interface UI, SUI; I/O means I/O, SI/O for arranging data transmission; and a central processing unit CPU comprising one or more processors. The memory MEM, SMEM comprises the non-volatile part of the central processing unit CPU, SCPU for storing controlling applications and other data to be preserved, and a volatile part to be used for temporary data processing. Management objects are stored in the memory MEM of the TE, and a management tree is maintained about their structure also in the memory SMEM of the server S. The TE functioning as a client device according to the OMA device management standard comprises the client agent CA that is responsible for the functions relating to a management session in the client device. The device S functioning as the management server comprises a server agent SA or server master SM attending to a management session. The client agent CA can be implemented by executing in the CPU a computer program code stored in the memory MEM, whereas the SA can be implemented by performing in the SCPU a computer program code stored in the memory SMEM. As noted earlier, TE and S can function as a management server and/or a client device. Thus, for instance the terminal TE may also comprise at least part of the functions of the server agent SA, in which case it can function as a management server in the synchronization between the terminals TE. Correspondingly, by means of computer program codes executed in the central processing units CPU, SCPU, the terminal TE and server S can be caused to implement inventive means related to specifying management nodes and informing about that. Some embodiments of these inventive means are illustrated in connection with FIGS. 4 and 5. A computer program can be stored in any memory means, for instance on a PC hard disk or CD-ROM, from where it can be loaded into the memory MEM, SMEM executing it. A computer program can also be loaded via a network, for example by using a TCP/IP protocol stack. Also hardware solutions or combinations of hardware and software solutions can be used to implement the inventive means. A data structure comprising a device description can be transmitted to the server S via a data transmission network, and stored in the memory of the server S.

FIGS. 4a and 4b illustrate a method according to the invention for updating a device management tree. FIG. 4a illustrates functions implemented in a client device, such as a terminal TE and more particularly in the client agent CA comprised by it. In step 400, a (management) node is specified in a client device, i.e. at least part of the node properties is specified independently in a client device. The node can be any dynamic node in a management tree. Step 400 can be entered when a totally new management tree is created, a new node is added to a management tree, or a node already comprised by a management tree is modified. In accordance with an embodiment, step 400 is performed immediately after the message comprising device management information has been received, when the client device must specify a name for at least one node. This message can be any provisioning message which comprises device management information, for instance an OMA device management message. A bootstrap message is also one provisioning message, being used upon initial provisioning for a device. Also the user can specify properties of one or more nodes. The user can modify the management tree, for instance by modifying the directory structure or renaming files that contain settings.

In step 401, the management tree is updated with a specified node. This means modifying information on any node or adding a data structure specifying a new interior node or leaf node and arranging access control in it. After this, the client device uses the modified management tree in a later device management session, for example. In step 402, at least the node information specified in the client device is transmitted to at least one management server, this information being in the following referred to as property information. It is to be noted that property information can be transmitted to the same management server from which the management command relating to this particular node was received, and/or to one or more other management servers. In accordance with one embodiment, information on the node modification is transmitted to those management servers that are specified in the ACL (Access Control List) of the node. Later on, different alternatives for transmitting this information will be described. It is to be noted that the client device may be arranged to perform step 402 immediately after the node has been created or it has been modified by a client device, or based on a check performed at a later stage, for example before establishing a device management session. In step 402, all information relating to the node specified by the client device or even all management tree nodes can be transmitted.

FIG. 4b, in turn, illustrates functions performed in a management server. In step 410, property information on at least one node is received from the client device, i.e. at least that node property information which the client device has specified. The management server is arranged to specify the modifications and/or additions made to the management information of the client device on the basis of the message received from the client device in accordance with the information contained in the message. In step 411, the management server updates and/or adds client-specific management information (where information corresponding to the management tree of the client device are specified) on the basis of the received node property information. Later, when the client device is to be managed and particularly When there is a need to address the node modified in step 411, management commands to be transmitted to the client device are formed 412 in accordance with the updated management information.

In accordance with one embodiment, the property information specified in the client device and to be transmitted to the management server comprise the node name. Since the node may have child nodes, at least the name of the node closest to the root node of all the above-mentioned information specified in the client device is transmitted, but not necessarily the information on the child nodes. Since the name of the node is used in the OMA device management to address a node in the management tree, the addressing can be arranged in accordance with the name specified by the client device. In the client device, nodes can be named in a manner appropriate for the implementation of the client device (for example with regard to the length and the letters used), and the management server can still address the nodes, when required, to update network settings, for example. By means of this embodiment, the folder structure of the information relating to device management, for example, can be specified, and at least the information on the modified node names can be sent to the management server, which then stores the modifications.

In one embodiment, the node name (typically received from the management server) is not changed in the client device, but it is located in a place not known to the management server. Thus, information on the location of the node (and thus also its child nodes) is transmitted to the management server, for instance by using a LocURI element. By means of this embodiment, the client device can locate management objects in a desired location, and in the management data of the management server, node locations are updated in accordance with the location information received from the client device.

In accordance with one embodiment, reference information is transmitted from the client device to the management server. This reference information may be brought about when, for example, a node added to the client device refers to another node.

The client device may be arranged to transmit any node property information, which the management server is then arranged to update to the management tree it maintains. Other node properties conforming to the OMA device management are described in the OMA specification “SyncML Device Management Tree and Description”, version 1.1.1; 2 Oct. 2002, 48 pages.

It is to be noted that it is not necessary to transmit node property information in the format in which it is specified and stored in the client device, but also other types of data presentation can be used, on the basis of which the management server is arranged to specify the modifications made by the client device to the management tree. A message comprising property information can utilize for instance references or a data compression technique applied by the client device and management server, such as hash coding. Only the modified information may be sent in the message, and it can be indicated that other information remains the same.

As presented in the above-mentioned OMA device management specification “SyncML Device Management Tree and Description”, Chapter 8, different vendors may create a device description for the management server by using a standardized DTD (Document Type Description) of a device description framework (DDF) or model, the device description containing device-specific property information. The DTD model of the device description specifies XML elements to which the device vendor can specify the properties of the device type in question and thus create a device description. On the basis of the device description, the management server is capable of transmitting management commands to different devices functioning as device management clients. The device description can, in particular, specify the external software structure of the client device for the part of the objects to be managed. In one embodiment, one or more pieces of information in the device description can be modified in the client device, for instance when a modification deviating from the current device description is made to the management tree. Information on this modification can also be transmitted to the management server that updates the device description. Instead of the above, other description frameworks and/or description models can be used, including for instance RDF (Resource Description Framework), CC/PP (Composite Capability/Preference Profiles), CIM (Common Information Model), GUP (Generic User Profile), XML Schema and UML (Unified Modeling Language).

In accordance with one embodiment, at least one node is specified in the first device in connection with a bootstrap process. The bootstrap process may be started for instance on the basis of a provisioning message transmitted by the management server, in which case the configuration specified by the message is installed in the client device. One example is the bootstrap plain profile of the OMA device management, in which settings required for starting a management session are offered to the client device. Another example is carrying out the WAP bootstrap process of the OMA device management. A general problem with unidirectional provisioning messages relating to device management is that settings must be named or otherwise changed in the client device in such a way that it is not possible for the management server to change them later. For instance, settings transmitted with the OMA client provisioning (OMA CP) technology do not directly refer to the management tree, but at least part of the management tree must be named separately by the client device. With the above method, however, property information of at least those nodes that the client device has modified can be transmitted to the management server. Particularly, name information that the client device has modified can thus be transmitted to the management server. Property information on the nodes modified in the bootstrap process can be transmitted as a reply to the received provisioning message or later on in a message relating to the establishment of a device management session in accordance with the OMA device management specification. After this, the management server and the client device can move on to use a bidirectional device management session. Thus, this allows generally common use of unidirectional provisioning technology, such as the OMA client provisioning technology OMA CP, and bidirectional device management technology, such as the OMA device management technology OMA DM.

In accordance with one embodiment, information on at least one node specified in the first device is transmitted to the second device in the establishment message of a device management session. Referring to FIG. 5a, the terminal TE functioning as the client device of the OMA device management is arranged to transmit 501 a management packet comprising at least the node information it has specified to the server S functioning as the management server by using a client initialization package #1. A client initialization package may contain an ALERT command, in which case the server S is arranged to add to its memory the information specified for the nodes in the ALERT command; or it may comprise a REPLACE command, in which case the server S is arranged to replace the information on the previous nodes in the package 501 with the information specified in the REPLACE command. After this, the management session can be continued, and the server S can transmit a server initialization package #2 502, which may now comprise management commands and management data. Further, the process can be carried on with packages #3 503 and #4 504. Thus, mechanisms of the device management protocol and messages specified for it can be utilized between the server S and the terminal TE. As regards a more detailed description of the OMA device management protocol, OMA specification “SyncML Device Management Protocol”, version 1.1. 1; 2 Oct. 2002 (39 pages) is incorporated as reference herein.

The following illustrates an exemplary client initialization package #1, for which the client device has specified an ALERT command, in the Item element of which the name specified for the node by the client device is specified. Other elements in the example are described in the OMA specification.

```
<SyncML xmlns=‘SYNCML:SYNCML1.1’>
    <SyncHdr>
    ...
    </SyncHdr>
    <SyncBody>
        ...
        <Alert>
            <CmdID>2</CmdID>
            <Data>1225</Data>
            <Item>
                <Data>7</Data> <!-Name given to dynamic node
by client device -->
            </Item>
        </Alert>
        ...
    </SyncBody>
</SyncML>
```

The following illustrates a second exemplary client initialization package #1, for which the client device has specified a REPLACE command, in the Item element of which the name specified for the node by the client device is specified. In the example, a new parameter “SrvInd” has been added to the DevInfo element, informing the management server that a new name (specified by the client device) must be stored for the dynamic node.

```
<SyncML xmlns=‘SYNCML:SYNCML1.1’>
    <SyncHdr>
    ...
    </SyncHdr>
    <SyncBody>
        ...
        <Replace>
        <CmdID>3</CmdID>
        <Item>
            <Source>
                <LocURI >./DevInfo/SrvInd</LocURI>
                <!-- ‘SrvInd’ stores name for dynamic
node-->
            </Source>
            <Meta>
                <Format
xmlns=‘syncml:metinf’>chr</Format>
                <Type xmlns=‘syncml:metinf’>text/plain</
Type>
            </Meta>
            <Data>7</Data> <!-Name given to dynamic node by
client device -->
        </Item>
        </Replace>
        ...
    </SyncBody>
</SyncML>
```

The following illustrates yet a third example of a client initialization package #1, for which the client device has specified a REPLACE command, in the LocURI element of which “7” indicates the name specified for the node by the client device.

```
<SyncML xmlns=‘SYNCML:SYNCML1.1’>
    <SyncHdr>
      ...
    </SyncHdr>
    <SyncBody>
        ...
            <Replace>
            <CmdID>3</CmdID>
            <Item>
                <Source>
                    <LocURI >./SyncML/DMAcc/7</LocURI>
                    <!- ‘7’ indicates name specified for
node by client device -->
                </Source>
            </Item>
            </Replace>
              ...
    </SyncBody>
</SyncML>
```

Deviating from the above embodiment, a completely new message can be specified, which is used for transmitting node-related property information from the client device to the management server. Property information can also be transmitted later in the device management session, for instance in package #3.

FIG. 5b illustrates another embodiment, in which the client device is arranged to create a reply message (reply indicator) 511 to the provisioning message 510 (OMA Client Provisioning) conforming to the OMA CP specification. Particularly, the client device is arranged to create a reply message if it has modified at least one node comprised by the provisioning message or at least one node in the management tree due to the provisioning message 510. The message 511 may be tailored exclusively for transmitting property information, but also elements already specified in the OMA device management protocol may be utilized. The message 511 may also indicate that creation of the management tree was successful or identify a possible error.

The messages illustrated in FIGS. 5a and 5b can be transmitted by using any transmission mechanism located below in a protocol stack. As illustrated in FIG. 2, the interface between the management server and the client device may vary. In a typical case, an operator of a PLMN network has a management server, whereby data transmission between the management server and the client device is implemented by utilizing a PLMN network and data transmission services provided by it. Property information may be transmitted by using for instance short messages (SMS; Short Message service), which are well suited for transmitting short text-based information. In accordance with another embodiment, the client device opens an HTTP connection to a predetermined address, for instance to a URL identifier reserved for the client device by the management server, and the property information can be transmitted via an HTTP connection. Here, CGI (Common Gateway Interface) scripts, for instance, may be utilized.

It is to be noted that the above embodiments may also be applied as combinations. To take an example, the initialization package 501 presented in FIG. 5a and comprising property information can be transmitted as a response to a provisioning message according to the OMA CP specification.

In accordance with one embodiment, the nodes whose property information has been specified in the client device are checked in the first device on the basis of a predetermined time interval or another checking criterion. Thus, a checking routine can be carried out in the client device, comparing for instance a provisioning message received previously from the management server and stored in the client device with nodes of the management tree, and specifying the differences. On the basis of the checking, at least the specified property information is then transmitted from the client device to the management server. In accordance with this embodiment, nodes can be specified in the client device, and information on the modifications made over a longer period of time can be transmitted to the management server only when needed. Alternatively, the modified property information can be transmitted immediately after the modification, or the modified information can be stored temporarily in a different location before the transmission.

In accordance with one embodiment, at least one transmission setting has been set in the client device for specifying the transmission moment of node property information. Property information is transmitted to the management server in accordance with the transmission settings determined for them. For example, there may be such a transmission setting in the client device according to which a modification made to a node comprising WAP access settings is transmitted to the management server, whereas a modification made to a node specifying ringing tones is not transmitted to the management server. Also, different transmission settings may be specified for different node property types; for instance, information on the node name being modified may always be transmitted to the management server. In accordance with one embodiment, the management server may specify transmission settings in the client device for different nodes and/or node property types.

In accordance with one embodiment, a transmission moment is specified in the transmission settings for the modified node and/or node property type in question. This can be done for example by specifying in the transmission settings a message after which, before which or during the transmission of which the property information must be transmitted. For instance, the modifications relevant for device management, such as modification of a node name, are arranged to be transmitted before the server initialization package (message 502 in FIG. 5a) in the client device initialization message (501) or as early as before starting the device management session. On the other hand, the client device can be arranged to transmit the modified property information that is less relevant for device management later on, for instance in package #3. In accordance with yet another embodiment, the client device is provided with first temporary data storage, in which the property information to be transmitted in accordance with a first transmission setting is specified, and with second data storage, in which the property information to be transmitted in accordance with a second transmission setting is specified. The client device is arranged to transmit property information to the management server from the first data storage in accordance with the first transmission setting, and from the second data storage in accordance with the second transmission setting. Thus, it is easy to collect modifications in centralized data storage in advance and then transmit all the collected modifications in accordance with the transmission settings.

It will be obvious to a person skilled in the art that with the advance of technology, the basic idea of the invention can be implemented in a plurality of ways. The invention and its embodiments are thus not restricted to the above examples but may vary within the scope of the claims.

1. A method for specifying information on a management node used for device management in a system comprising a first device and a second device managing the first device, the method comprising:
specifying at least one piece of management node information in the first device as a response to a message received from the second device, and
transmitting at least one piece of management node information specified by the first device from the first device to the second device as a response to at least one piece of management node information being specified in the first device.

2. A method according to claim 1, wherein at least one piece of information on at least one management node is specified in the second device in accordance with the message received from the first device.

3. A method according to claims 1, wherein the specification of the information on the at least one management node and transmitting it is carried out as a response to a management message received from the second device.

4. A method according to claim 3, wherein the management message received from the second device is a unidirectional provisioning message.

5. A method according to claim 1, wherein the information on the at least one management node comprises at least the name or the location of the node in the management structure.

6. A method according to claim 1, wherein the information on the at least one management node specified in the first device is transmitted to the second device in the establishment message of a device management session.

7. A method according to claim 1, wherein at least one transmission setting is set in the first device for specifying the transmission of the information on the at least one management node; and
information is transmitted to the second device in accordance with the transmission setting.

8. A method according to claim 7, wherein a first temporary data storage is arranged in the first device, in which first temporary data storage the information to be transmitted in accordance with the first transmission setting is specified, and a second data storage is arranged, in which second data storage the information to be transmitted in accordance with the second transmission setting is specified; and
information to the second device is transmitted from the first data storage in accordance with the first transmission setting and from the second data storage in accordance with the second transmission setting.

9. A method according to claim 1, wherein the first device is a client device conforming to the OMA device management standard, the second device is a device management server conforming to the OMA device management standard, and the method is applied to specifying nodes in a OMA device management tree.

10. A device management system comprising a first device and a second device managing the first device, wherein the first device is configured to specify at least one piece of management node information as a response to a message received from the second device, and
the first device is configured to transmit at least one piece of management node information specified by the first device to the second device as a response to at least one piece of management node information being specified in the first device.

11. A data processing device configured to function as the client device in device management and to specify information on at least one management node as a response to a message received from the management server, wherein the data processing device is configured to transmit information on the at least one management node, specified by the data processing device, to a management server as a response to information on at least one management node being specified in the data processing device.

12. A data processing device according to claim 11, wherein the data processing device is configured to specify information on the at least one management node and to transmit it as a response to a management message received from the management server.

13. A data processing device according to claim 11, wherein the information on the at least one management node comprises at least the name and the location of the node in the management structure.

14. A data processing device according to claim 11, wherein the data processing device is configured to transmit the information on the at least one management node, specified in the data processing device, to the management server in the establishment message of a device management session.

15. A data processing device according to claim 11, wherein at least one transmission setting is set in the data processing device for specifying the transmission of the information on the at least one management node, and
the data processing device is configured to transmit information to the management server in accordance with the transmission settings.

16. A data processing device according to claim 11, wherein the data processing device is a client device conforming to the OMA device management standard.

17. A data processing device configured to function as the management server in device management, wherein the data processing device is configured to check at least one piece of information on at least one management node, specified by the client device as a response to a message received from the data processing device, from a message received from the client device, and
the data processing device is configured to update, on the basis of the checking, management information maintained in the data processing device.

18. A computer program product loadable to the memory of a data processing device, wherein the computer program product comprises a computer program code, which, when executed in the processor of the data processing device configured as the client device in device management, causes the data processing device to transmit to the management server information on at least one management node, specified in the data processing device as a response to a message received from the management server, as a response to the data processing device having specified the information on the at least one management node.
